(19) United States
(12) Patent Application Publication
(10) Pub. No.: US 2017/0293950 A1
(43) Pub. Date: Oct. 12, 2017

(54) System and method for user selected arranging of transport

(71) Applicant: Yogesh Rathod, Mumbai (IN)

(72) Inventor: Yogesh Rathod, Mumbai (IN)

(21) Appl. No.: 15/635,223

(22) Filed: Jun. 28, 2017

Related U.S. Application Data
(63) Continuation of application No. PCT/IB2015/052640, filed on Apr. 11, 2015.

(51) Int. Cl. G06Q 30/02; G06Q 10/02; G06Q 20/10

(52) U.S. Cl. CPC G06Q 30/0283; G06Q 20/102; G06Q 10/02; G06F 3/04817

(57) ABSTRACT

Various embodiments of a system, methods, platform, database, search engine, device & marketplace for enabling on-demand service providers to list & present on-demand services to contextual prospective on-demand service consumers on user interface or real-time updated map for enabling prospective or searching on-demand service consumers to search, match, filter, view, select and/or select one or more contextual user actions, send, accept or reject request(s), send indication(s) of interest to consume services directly to one or more service providers via on-demand service(s) server(s) and/or enable to view approximate time and/or distance to reach or arrive service provider(s) or user(s) and/or optionally enable to verify, view user or service provider or service profile, compare, negotiate, bid, provide or notify various status, confirm, consume, communicate, rate & review service provider(s) and/or user(s).

This is a continuation of International Application PCT/IB2015/052640, with an international filing date of 11 Apr. 2015, having title: Real-time presenting on-demand service providers and users or customers and facilitating them.

### FIELD OF INVENTION

The present invention relates generally to real-time presenting on map on-demand service providers including cabs, various types of vehicles, food delivery, deliver, food & grocery, supply chain & logistics, home services, and various forms of travel, plumber, electrician, mechanic, maid, cleaner, package delivery, local meals, business services, health services, on demand rooms, freelancers, local shops or sellers or vendors, lawyers, tutor, doctors, support, courier, laundry, flower delivery, repair, car wash, ice cream providers, retailors, carpenter, tailor and matched current or prospective or potential customers including passengers, clients, subscribers, guests and facilitating them including enable them to search, match, select, show nearest and available or available within or after or during particular period of time, provide contextual user actions & options including send, view & accept request(s), send indications of stopping or arriving or waiting, send, receive & view notifications, book or buy or order or subscribe, get advance (schedule date & time) book or order or appointment, view profile, bid, offer, view and provide ratings & reviews, calculate estimated time to arrive, view profile and statistics, view associate details including rate card, subscription fees, charge models, send or receive messages, share media, ask, view & invite references, view or set various types of user provided status or automatic status including available, busy, near to available or available within particular time, request send, request received, confirm, pending, booked, arriving, arrived, wait, cancel, start trip, end trip, payment made, provided ratings & reviews & like, make various types of payments, view, logs, events & activities, view or update transaction details, write notes and like. Embodiments described herein pertain generally to a system and method for real-time presenting updated on-demand service providers and contextual customers or passengers or clients and facilitating in providing on-demand services through use of portable computing devices.

### BACKGROUND OF THE INVENTION

Current on-demand services, such as fleet management systems employed for Taxi and limousine fleets, typically utilize and provides driver and passenger application through which passenger can send request including pick up & drop off location and type of selected cab which system present to matched nearest available cab driver who can accept or reject the request. After accepting request by cab driver system sends notification to said passenger. System also tracks location, estimated time, meter and various status including request accepted, driver or cab arriving or arrived, trip start and trip end etc. and notify passenger and driver. But to provide these services cab companies employ various terms & conditions on cab drivers including minimum fare, dress code, cut percentage of fare as commission for Cab Company and dispatcher or intermediary service providers and also gets rights to route request to particular cab driver on their hand.

Present invention enables on demand service providers and current or prospective customers or clients or passengers to find out each other and facilitate in activities, actions, interactions, communications, searching, matching, collaboration, workflow, tasks, management, events and transactions between or among them. Present invention enables viewing, accessing, mapping, bookmarking, referring, sharing, sorting, filtering, searching, matching, suggesting, selecting, requesting, accepting requests, conducting one or more activities, participations, interactions, collaborating, communicating, transacting real-time presented and updated on-demand service providers and users or customers.

Therefore, it is with respect to these considerations and others that the present invention has been made

### Object of the Invention

The principal object of the present invention is to real time present or show & update listed on demand service providers including online & available or available within particular duration and logged or online users, current or prospective consumers including clients, customers, passengers, and subscribers, so they can easily identify, search, match each other and transaction with each other including search, match, browse, navigate on map, select, refer, suggest & identify, send or accept request(s), notify various status to each other, book cab or one or more type of selected service provider(s), make payment via various preferred or mutually preferred payments including credit or debit card, net banking, virtual money, cash, installments, payment modes, schemes & models & like, create group and enable to invite, accept invitations, add or remove or join members, know approximate or estimated time when customer can consume said one or more on demand services or estimated time of arrival or providing on demand services to customer, order food, book appointment at available date & time, real-time know when on-demand service provider is free & available and how far, negotiate, communicate & bid with them, provide ratings & reviews, track arrival of particular type of vehicle on map via application user on said vehicle, provide support.

The other object of the present invention is to eliminate intermediary between on demand service provider and consumer from platform and directly enable them to search & match each other and transact with each other on their own terms, system, conditions, time, fare & method.

The other object of the present invention is to enable passenger of bus or other vehicle to identify that when or from where bus is arrive including estimated time of arrival at bus stop and view real-time updated location of particular bus on map based on real-time updated location of one or more present invention application users in said bus or vehicle.

The other object of the present invention is to track arriving or arrival vehicle of related person(s).

The other object of the present invention is provide peer to peer on-demand service providing & consuming platform, marketplace and presenting, listing, searching, matching, filtering, indicating, requesting and transacting on-demand services including providing estimated time and/or distance to reach to service provider(s) or arrive by service provider(s).

The other object of the present invention is to enabling users to physically search, match, select, identify, converse with seller, view provided information, compare, bid, negotiate, book, order, purchase, like, rate products and services and also real-time identify route or turn by turn map, approximate time to reach there based on real-time updated location of one or more present invention application or device users in said location, area, shop, mall, home & like.

The other object of the present invention is to real time present preferences and selections specific products, services, shops, restaurants, home, establishments, vehicles, on demand service providers, sellers, users, customers, clients, friends, connected users, contacts, relatives who allow or opt-in to showing them real-time on map or listed on our application & service(s).

The other object of the present invention is to enabling user(s) or prospective service consumer(s) to select service provider(s) based on user preferences or after reviewing or analyzing or auto matching or selecting from suggested or selecting and reviewing rank(s), reviews, relationship(s) or contact(s) or connection(s), subscription(s), bookmark(s) or favorite(s), reference(s), comparative price(s) or bid(s) or offer(s) or negotiation(s) or estimated fare(s) or rate(s), accepted type of payment mode(s), conversations or communications, provided information including profile of service provider & service(s), accepted indications or requests, nearest locations, estimated or approximate time to arrive, type & brand of service providers e.g. bust or cab or rickshaw or Sedan car or Mercedes car or sharable etc., past service consuming or transactions, current status, quality with/for/of service provider(s) or service(s).

The other object of the present invention is to enabling service provider(s) to select user(s) or prospective service consumer(s) based on service provider's preferences or after reviewing or analyzing or auto matching or selecting from suggested or selecting and reviewing rank(s), reviews, relationship(s) or contact(s) or connection(s), subscription(s), bookmark(s) or favorite(s), reference(s), accepted price(s) or bid(s) or offer(s) or negotiation(s) or estimated fare(s) or rate(s), selected routes, pickup or drop off location, accepted type of payment mode(s), conversations or communications, provided information including profile of user(s) or service consumer(s), accepted indications or confirmed requests, nearest locations, estimated or approximate time to arrive or reach, past service providing or transactions, current status, quality by/with/for/of user(s) or prospective service consumer(s) or passenger(s) or actual customer(s).

The other object of the present invention is to provide complete transparency in listing, pricing, searching, matching, presenting, selecting, comparing, ranking, bidding, offering, requesting, accepting payment modes, negotiating of providing or consuming on-demand services

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Embodiments described herein provide an interactive environment for enabling user(s) and on-demand service provider(s) to list on real-time updated map, identify each other including identify nearest, available, available within particular duration, send or accept request directly from/to each other, facilitate or enable in conducting one or more types of actions, activities, interactions, workflow, tasks, follow-ups, events, transactions, communication, collaboration using a computing device. In particular, some embodiments described herein enable mobile computing devices, such as smart phones and geo-aware cellular telephony devices, to be used in connection with an on-demand service that enables the user to search, match, browse, filter & view services, such as a delivery service or transport service, using a simplified user interface schematic. Functionality, such as communicating the location of the user, the location of available service providers, the types of service available, the estimated fees and other information, can be aggregated and provided to the user in an efficient and user-friendly manner.

In one embodiment, a computing device can operate an application for enabling to view, search, match, filter, browse, navigate, select one or more prospective users including customers, clients, students, passengers & like and/or on-demand service providers. The application can provide user interface features that provide a user of the application with information for enabling the user to view, search, match, filter, browse, navigate, and select one or more or a particular type of service(s) or service providers or prospective customers or users and conduct one or more types of actions, selections, activities, participations, communications, collaborations, interactions, & transactions and send or receive requests, view profile & account, make, track & note payments using one or more types of modes or schemes of payments, view or update various types of status, view estimated distance & time to reach or arrival, ask for reference(s), view or provide ratings & reviews, view, calculate, analyze and compare rate, cost, price, charge, bid, offers & discounts. For example, the user can be provided a mechanism for selecting services and service types, as well as displaying information that may affect the decision of the user in making such selections.

According to some embodiments, the information and service options made available to the user can be one or more selection specific. In another embodiment different on-demand services and information about different services can be provided to the user based on the one or more types of selections, filters e.g. area that the user is located in. Thus, the service options made available to the user, as well as the information provided to the user regarding the service options can be made selections or filter specific.

In some embodiments, different user interface features can be provided, at least in part, by an application or program that is stored and operated on the user's computing device. The application can be configured to communicate with an on-demand service system that presents contextual service between users and service providers (e.g., drivers for transport, ice cream delivery providers, food delivery, deliver, food & grocery, supply chain & logistics, home services, and various forms of travel, plumber, electrician, mechanic, maid, cleaner, package delivery, local meals, business services, health services, on demand rooms, freelancers, lawyers, tutor, doctors, support, courier, laundry, flower delivery, repair, car wash, ice creams, carpenter, tailor etc.). For example, a user can request food to be delivered to his or her office, and the on-demand service system can present available food providers that satisfy the user's preferences and enable user to select and directly order to a food provider to perform the service. The user is enabled, via the user interface features, to make different selections for viewing specified information and for requesting different on-demand service options based on the user selections.

According to an embodiment, a location of the computing device can be determined so that user interface features for requesting an on-demand service can be presented, on a display of the computing device, based on the device's real-time location. A selection feature can be provided to enable a user to select a particular type of service. In one implementation, the selection feature identifies a plurality of service options for an on-demand service (e.g., types of vehicles that can provide a transport service for the user e.g. cab, rickshaw & bus, types of food, type of payment methods or delivery methods, etc.), based on a area where the user is located (e.g. the device's real-time location).

In one embodiment, a user interface can be presented on the display in response to the user selecting one of the plurality of the service options, such as a vehicle type for a delivery or transport, or type of food service. The user interface can include area-specific information about the on-demand service that is particular to and based on the selected service option. For example, for an on-demand food service, the user interface can include area-specific information about the closest cabs or food service providers, types of foods available in the area, average prices for the foods, the inventory available, etc. In another example, the area-specific information can include an estimated time of arrival to the user's current location, the average price, the amount of space/capacity of the vehicle, etc. The provided information can assist the user in making a better informed decision in requesting the on-demand service. In some implementations, the user can interact with the selection feature by selecting different service types or service options to make the contents within the user interface to dynamically update accordingly.

Still further, in some embodiments, when the user or service provider select or tap the icon representing one or more type of on-demand service provider, system generates and presents contextual user actions menu to user including he/she is interested to travel or catch particular type or particular selected vehicle e.g. particular selected or preferred cab or rickshaw or particular number of bus, provide pickup and drop off information, ask for price or rate or current rate, bid, offer premium price or rate or fare, communicate with them, provide or select one or more types of preferred or accepted payment modes e.g. cash, credit card, net banking, swipe credit card via mobile (e.g. Square), use integrated payment via e.g. Stripe, pay via installments & provide or pay after particular period or duration of credit facility, ask for reference, view profile, ratings & reviews, ask for vehicle or driver or service provider details including type or condition of vehicle, passenger capacity, service provided, accepted payment mode, rate, policies, rules, terms & conditions, other possible charges like toll, driver charge, extra charge & like, service provider can indicate that he/she is coming to catch passenger or provide services to customers, calculate or view approximate or estimate distance and/or time to arrival or reach, provide or view various status including interested to hire, request to book, accept request, like, show virtual hand to stop vehicle e,g. cab or rickshaw, arriving, arrived, start trip or start providing or using service, end trip or end providing or using service, select or offer mode of payments, make direct payment and provide or view details of payment & provide or view various notifications. User can view or analyze details of or communicate with multiple service providers to search, match, compare, negotiate, identify & select best matched and then send request or book or send indication to cab or service provider(s) at present or at particular date & time.

As described herein, a “user,” or a “customer” refer to individuals that are viewing, searching, matching, browsing, navigating, selecting, sending indication of interest in services, negotiating, bidding, analyzing, comparing, requesting or ordering an on-demand service. Also as described herein, a “provider,” or a “service provider” refer to individuals or entities that can list and provide the requested service and viewing, searching, matching, browsing, navigating, selecting, sending indication of interest, negotiating, bidding, analyzing, comparing, accepting or confirming request of prospective users including customers, passengers, clients, students & like. As an example, a user can view, search, match, select, compare, negotiate, ask for more details or communicate one on-demand services and service providers (e.g., cab, rickshaw, bus service, food delivery, deliver, food & grocery, supply chain & logistics, home services, and various forms of travel, plumber, electrician, mechanic, maid, cleaner, package delivery, local meals, business services, health services, On demand rooms, freelancers, lawyers, tutor, doctors, support, courier, laundry, flower delivery, repair, car wash, ice creams, carpenter, tailor, & provide a product) using the system, and a service provider can communicate with the system and/or the user to search, match, select, indicate interest, like, confirm, ask details, negotiate, compare to perform the service. In addition, as described herein, “customer devices” and “provider devices” refer to computing devices that can correspond to desktop computers, cellular or smartphones, personal digital assistants (PDAs), laptop computers, tablet devices, television (IP Television), etc., that can provide network connectivity and processing resources for enabling a user to communicate with a system over a network.

In an important embodiment or broader embodiment identify users and/or service providers or current or updated location of users and/or service providers who are online and present representations of them (e.g. icon or name or image) on user interface (e.g. map etc.) and enabling user(s) or service provider(s) to view, search, match, navigate, browse, filter & select online, available or available within particular duration or date & time and nearest to their current or matched or selected or navigated location specific user(s) and/or service provider(s) or updated user(s) and/or service provider(s).

In an another embodiment identify users including movable or stable or fixed users and/or service providers including movable or stable or fixed service providers who are online and present representations of them (e.g. icon or name or image) on user interface (e.g. map etc.) and enabling user(s) or service provider(s) to view, search, match, navigate, browse, filter & select online, available or available within particular duration or date & time and nearest to their current or matched or selected or navigated location specific user(s) and/or service provider(s) or updated user(s) and/or service provider(s) and enable user to send indication of interest or non-interest of consuming service, send request to service providers, accept or reject service provider, identify estimated time of arrival, real-time identify updated location of service provider on map and service provider can also send indication of interest of providing service, accept or reject request of prospective consumers of service of service provider, identify estimated time of reach at one or more prospective consumers, real-time identify updated location of one or more prospective consumers on map.

In an another embodiment enabling real-time presenting, listing, updating, searching, matching, filtering on-demand services, service providers & consumers or users and facilitating in providing & consuming on-demand services comprising: identify and update current location of consumers or users who are online or interested in consuming on-demand services; identify and update current location of on-demand service providers who are online and available or available within/at particular duration; present said consumers or users and on-demand service providers on interface including map interface; enable to identify or present or indicate on map updated location, distance & approximate or estimated time to arrive or reach between on-demand prospective or actual consumers or users and services or service providers and any combination thereof; and enable prospective or actual on-demand service provider(s) and/or consumer(s) to view, search, match, filter, select or identify one or more type(s) of on-demand service provider(s) and/or consumer(s) or user(s) including online, near or around or selected or suggested or inputted or identified location specific and available on-demand service provider(s) and consumer(s), provide or exchange or view updated or selective information, profile, user data, location(s), rating & reviews, distance, duration to reach or arrive & various types of status or indications, send indication of interest to consume service(s) of particular service provider(s), send request(s) to auto matched service provider(s) or to match service provider(s) based on preference or user data, accept request(s) of one or more preferred prospective consumers or users, send request(s) of particular service provider(s), accept request(s) of particular user(s) or prospective consumer(s), send or receive notification(s), preferences, select one or more types of options or user actions and conduct one or more searching, matching, filtering, selections, actions, activities, events, interactions, invitations, tasks, workflow, referring, grouping, negotiations, bidding, offering, booking, e-commerce (e.g. buying or selling), comparison, participations, communications, collaborations & transactions or make payments via one or more payment modes.

In an another embodiment on-demand service providers includes drivers, users of application, web site, network, service & device, food delivery, deliver, food & grocery, supply chain & logistics, home services, and various forms of travel, plumber, electrician, mechanic, maid, cleaner, package delivery, local meals, business services, health services, rooms, freelancers, lawyers, tutor, doctors, support, courier, laundry, flower delivery, repair, car wash, ice creams, carpenter, tailor and like.

In an another embodiment on-demand service provider is verified user.

In an another embodiment identify, determine, identify current, auto matched and auto select one or more location(s) of user(s) and/or on-demand service provider(s) and enable user.

In an another embodiment on-demand service provider to select, select from suggested or matched or bookmarked or favorite or like locations or location from log history.

In an another embodiment calculating, updating and presenting updated distance from location of searching user or user to location of said one or more or on-demand service providers and/or calculate approximate or estimate time to reach from said location of searching user to said location of said one or more or on-demand service providers.

In an another embodiment suggest or enable searching users or on-demand service providers turn by turn location of said one or more listed on-demand service providers or identified users or one or more prospective customer(s).

In an another embodiment one or more or on-demand service providers including selected, request accepted, bookmarked or favorite, connected or related or in contacts, select from past used, suggested, auto matched on-demand service providers.

In an another embodiment auto send request or indication of interest to consume services to service providers and/or send request or indication of interest to provide services to users based on identification of current location, online status, availability, match making preferences, preferences including type & budget, bookmarked or favorite service providers, user profile, ratings & comments, relationship or connections or contacts, subscription service(s).

In an another embodiment service provider can manually select prospective consumer or users including manually select contextual user actions including bookmark, hide, show, deny, view profile& status, ask for information, communicate, provide ratings & comments, select and send request, send indication of interest to provide service(s), accept or reject request, ask for bid or provide quote or information, request more information, communicate, make payment, take one or more user actions.

In an another embodiment user(s) or prospective consumer(s) can manually select service provider(s) including manually select contextual user actions including bookmark, hide, show, deny, view profile & status, ask for information, communicate, provide ratings & comments, select and send request, send indication of interest to consume service(s), accept or reject request, ask for or provide bid, view quote or view or request more information, make payment communicate, take one or more user actions.

In an another embodiment enable user or service provider to list one or more physical structure including shop, department within shop, one or more types of vehicle including bus, government bus, one or more products within that shop, mall, class, college, school, selling or service points, manufacturing company, warehouse, company, office, house or home, building, land, tourist place, park, parking area, temple, road, mountain, river, forest, tree and like as well as employee or service providers including salesman, delivery boy, experts, manager, seller, guide, consultant, particular named person and like, wherein identify, bookmark, track & store location of one or more type of said entity based on presence of user at/in that location or user location. In an another embodiment said user is verified user. In an another embodiment enable to provide and store details and resources of said entity including profile, name, address, bus number, bus route, bus fare, current status & information about bus including seat availability & traffic, list of products & services, information about shop or home on rent or lease or for sale, list of available products, details of products including price, name, description, quantity in stock, discount & like, menu, line of web site, application to order, book, purchase, bid, like, rate, review, negotiate one or more products or services, communicate with sales person, manager, expert & owner of shop, wherein present said listed entity on map. In an another embodiment enable users to identify location of said entity from current location of searching or viewing user. In an another embodiment displaying path from location of searching user to location of said one or more entity. In an another embodiment calculating, updating and presenting updated distance from current location of searching user to stored location of said one or more entity and/or calculate approximate or estimate time to reach from said current location of searching user to said stored location of said one or more entity. In an another embodiment suggest or enable searching users turn by turn location of said one or more listed entity.

In an another embodiment suggest nearest users or consumers or passengers to on-demand service providers.

In an another embodiment suggest nearest on-demand service providers to users or consumers or passengers.

In an another embodiment provide turn by turn location of selected users or consumers or passengers to on-demand service providers.

In an another embodiment provide turn by turn location of selected on-demand service providers to users or consumers or passengers.

In an another embodiment present said matched or contextual or related online, available and/or nearest on-demand service providers on interface including on map interface to user based on current location of prospective consumer or user or passenger or selected location(s) by prospective consumer or user or passenger.

In an another embodiment present said matched or contextual or related online, interested to consume service(s) and/or nearest on-demand prospective service consumers on interface including on map interface to service provider based on current location of service provider or selected location(s) by service provider.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an example system for enabling a user to request on-demand services using a computing device, under an embodiment.

FIG. 2 illustrate examples of user interfaces that are displayed to a user to enable the user to select various options, set role, set status, provide preferences & privacy settings, filter or select type of service providers, provide additional information, and request an on-demand service, provide search keywords, select from directory, according to an embodiment.

FIG. 3 illustrate examples of user interfaces that are displayed to a service provider to enable the to select various options, set role, set status, provide preferences & privacy settings, filter or select type of prospective consumers, provide additional information, provide search keywords, select from directory, according to an embodiment.

FIG. 4 illustrate examples of user interfaces that are displayed to a user to enable the user to view preferred, online, available, interested to provide service(s) & nearest or within particular radius service providers and/or enable service provider to view preferred, online, interested to consume service(s), & nearest or within particular radius users or prospective consumers and enable to search, match, select, send or accept or reject request or indication of interest to provide or consume service(s) to one or more auto matched or selected or preferred service providers or users or prospective consumers, view estimated or updated time to arrive or reach of one or more preferred or selected service providers or users or prospective consumers, view updated current location of service providers or users, view or set various types of status, request an on-demand service, present one or more contextual user actions & enable take one or more user actions, according to an embodiment.

FIG. 5 illustrates an example method for enabling a user to view, search, and match, select & directly request on-demand services without any intermediary (e.g. intermediary service including dispatching service provider or car service company) using a computing device, according to an embodiment.

FIG. 6 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

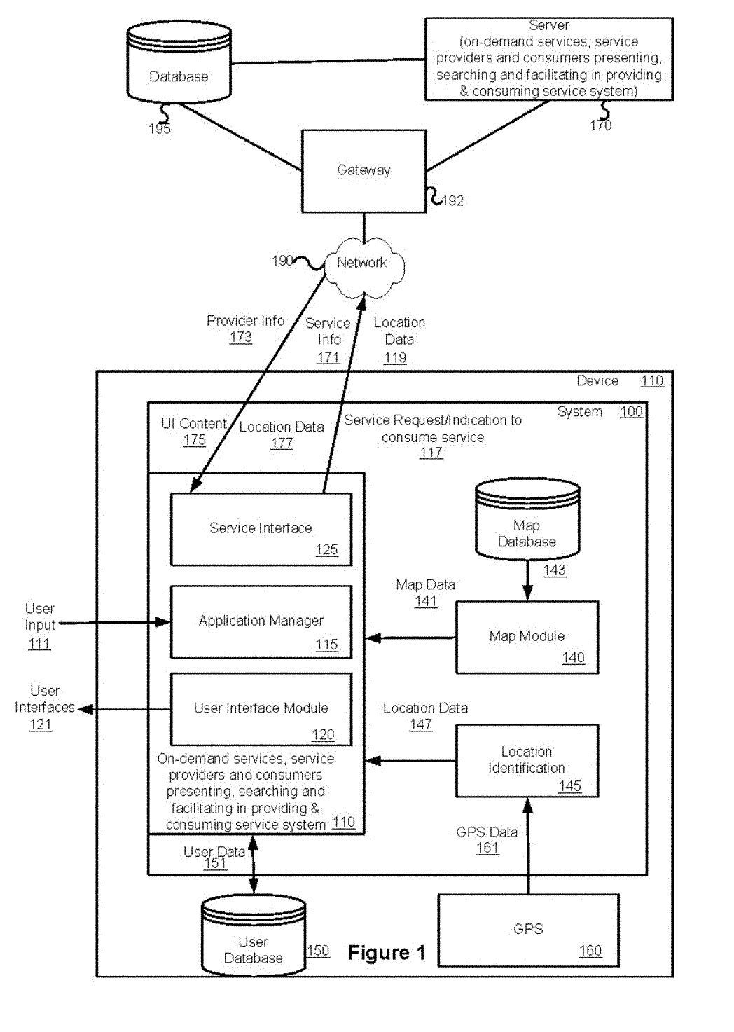

FIG. 1 illustrates an example on-demand service, on-demand service providers & prospective consumers' directory, search engine, platform and marketplace user interface system, under an embodiment. According to some embodiments, system 100 can be implemented through software that operates on a portable computing device, such as a mobile computing device 110. System 100 can be configured to communicate with one or more network services, databases, objects that coordinate, orchestrate or otherwise provide on-demand services. Additionally, the mobile computing device can integrate third-party services which enable further functionality through system 100.

As an alternative or addition, some or all of the components of system 100 can be implemented on one or more computing devices, such as on one or more servers or other mobile computing devices. System 100 can also be implemented through other computer systems in alternative architectures (e.g., peer-to-peer networks, etc.). Accordingly, system 100 can use data provided by an on-demand service searching & providing/consuming service system, data provided by other components of the mobile computing device, and information provided by a user in order to present user interface features and functionality for enabling the user to view, search, match, filter, identify or determine location and estimate time to arrive or reach, notify, book, transact and request an on-demand service. The user interface features can be specific to the location or area that the computing device is located in, so that area-specific information can be provided to the user. System 100 can also update the user interface features, including the content displayed as part of the user interface features, based on other user selections.

In some implementations, system 100 includes an on-demand service searching & providing/consuming service application 110, a map component 140, a map database 143, and location identification 145. The components of system 100 can combine to provide user interface features that are specific to user selections, user actions, activities, events, behavior, transactions & logs, user data, user location, user preferences & privacy settings to enable a user to view, access, search, match, select, notify, communicate, collaborate, negotiate, view or ask information, transact, & request on-demand services. The on-demand service application 110 can correspond to a program that is downloaded onto a smartphone, portable computer device (e.g., tablet or other location-aware device). In one implementation, a user can download and install the on-demand service application 110 on his or her computing device and register the computing device 110 with an on-demand service system.

The on-demand service searching & providing/consuming service application 110 can include an application manager 115, a user interface (UI) component 120, and a service interface 125. The service interface 125 can be used to handle communications exchanged between the on-demand service searching & providing/consuming service application 110 and the on-demand service searching & providing/consuming service system 170 (e.g., over a network). For example, the service interface 125 can use one or more network resources of the device 110 for exchanging communications over a wireless network. The network resources can include, for example, a cellular data/voice interface to enable the device to receive and send network communications over a cellular transport. As an alternative or variation, the network resources can include a wireless network interface for connecting to access points or for using other types of wireless mediums.

The application manager 115 can receive user input 111, location information 147, and other information (such as user information 151) to configure content that is to be provided by the UI component 120. For example, the UI component 120 can cause various user interface features 121 to be output to a display of the computing device 110. Some of the user interface features 121 can be area-specific (e.g., based on the current location of the computing device) to display information that is particular to the area. The user interface features 121 can also provide dynamically updated content based on user selections provided via the user input 111.

For example, the UI component 120 uses a UI framework that can be configured with various content, such as UI content 175 provided by the on-demand service searching & providing/consuming service system 170 and content as a result of user input 111. The UI component 120 can also configure the UI framework with location information 147 and map content 141. In this manner, a map of a area in which the user is currently located in can be displayed as part of a user interface feature 121. In some examples, the map component 140 can provide the map content 141 using map data stored in one or more map databases 143. Based on the locale of the user and the user selection(s) made for requesting an on-demand service, such as a type of food or a type of vehicle that the user would like to be transported in, the application manager 115 can cause area-specific and user-selection-specific UI content 175 to be presented with or as part of a user interface 121.

In some implementations, the user interfaces 121 can be configured by the application manager 115 to display information about on-demand services that are available for the user-specific area. On-demand services can include order food & grocery delivery, request supply chain & logistics, home services, travel services, plumber, electrician, mechanic, maid, cleaner, order package delivery, local meals, request business services, health services, request availability of rooms, request freelancers, lawyers, tutor, doctors, support, courier, laundry, flower delivery, repair, car wash, ice creams, carpenter, tailor, deliver, hawkers services or other services that the user wants to search and can request via the on-demand service searching & providing/consuming service system. Based on the user's area, different services and service options can be available for the user.

For example, for an on-demand transport service, vehicles may be available in one city, and unavailable in another. In various examples described, the user interfaces 121, which displays information about services available for a user, as well as features to enable the user to request services, can be configured with network user interface content (e.g., provided by the on-demand service system 170) to reflect the services available to the user based on the user's geographic area, type of services, and user profile. The user is enabled to interact with the different displayed user interface features 121, via the user input 111, to make selections and input preferences when requesting an on-demand service from the on-demand service searching & providing/consuming service system 170.

When the on-demand service application 110 is operated by the user, the various user interfaces 121 can be rendered to the user based on the user inputs 111 and/or information received from the on-demand service searching & providing/consuming service system 170. These user interfaces include, for example, a home page user interface (e.g., an initial page or launch page), a selection feature, a presentation user interface, contextual user actions menu or interface, a location suggestion user interface, a location search user interface, a confirmation user interface, or a combination of any of the features described. For example, the UI component 120 can cause a home page user interface 121 to be displayed that identifies the service(s) that the user can request using the on-demand service searching & providing/consuming service application 110. The home page user interface 121 can also provide only certain service selection options or types that are available in the user's area. In this manner, based on the current location of the computing device, the on-demand service searching & providing/consuming service application 110 can cause location-specific user interfaces 121 and content to be presented to the user.

In many instances, a geographic area that is specific to the user can be based on the user's current location (e.g., the current location of the computing device 110) or the user's requested service location (e.g., the pickup location for a transport service, or a delivery location for a food service). For example, in some cases, the current location can be different from the requested service location, so that the user can manually select a particular pickup location or delivery location that is different from the current location of the computing device 110. The user's current location or service performance location can be determined by the location determination 145.

The location determination 145 can determine the location of the computing device in different ways. In one example, the location determination 145 can receive global positioning system (GPS) data 161 from location-based/location-aware resources 160 of the computing device 110. In addition, the location identification 145 can also receive GPS data 161 from other applications or programs that operate on the computing device 160. For example, system 100 can communicate with one or more other applications using one or more application program interfaces (APIs). The on-demand service searching & providing/consuming service application 110 can use the location information 147 to cause the UI component 120 to configure the UI framework based on the location information 147. In addition, the on-demand service searching & providing/consuming service application 110 can provide the user's location data 119 to the on-demand service searching & providing/consuming service system 170.

As an addition or alternative, the on-demand service searching & providing/consuming service application 110 can determine the user's current location or pickup location (i) by using location data 177 provided by the on-demand service searching & providing/consuming service system 170, (ii) by using user location input provided by the user (via a user input 111), and/or (iii) by using user data 151 stored in one or more user databases 150.

For example, the on-demand service searching & providing/consuming service system 170 can cross-reference the location data 119 (received from the on-demand service searching & providing/consuming service application 110) with the other sources or databases (e.g., third party servers and systems) that maintain location information to obtain granular/specific data about the particular identified location. In some cases, by cross-referencing the data, the on-demand service searching & providing/consuming service system 170 can identify particular stores, restaurants, apartment complexes, venues, street addresses, etc., that are proximate to and/or located at the identified location, and provide this information as location data 177 to the on-demand service application 110. The application manager 115 can cause the UI component 120 to provide the specific location information as part of the user interface 121 so that the user can select a particular store or venue as the current location or the service performance location (e.g., a pick up location or delivery location).

The on-demand service searching & providing/consuming service application 110 can also receive user location input provided by the user to determine the current location or service location of the user. In one example, the on-demand service application 110 can cause the UI component 120 to present a location search user interface on the display. The user can input a search term to identify stores, restaurants, venues, addresses, etc., that the user wishes to request the on-demand service. The on-demand service searching & providing/consuming service application 110 can perform the search by querying one or more external sources to provide the search results to the user. In some variations, the user can manually provide user location input by entering an address (e.g., with a number, street, city, state) or by manipulating and moving a service location graphic/icon on a map that is displayed as part of a user interface 121. In response to the user selection, the on-demand service searching & providing/consuming service application 110 can provide the location data 119 to the on-demand service searching & providing/consuming service system 170.

In another variation, the on-demand service searching & providing/consuming service application 110 can retrieve and use user data 151 that are stored in a user database 150. The user database 150 can include records of the user's previous on-demand service requests or interests as well as user preferences. In some implementations, the user database 150 can be stored remotely at the on-demand service searching & providing/consuming service system 170 and user information can be retrieved from the on-demand service searching & providing/consuming service system 170. The on-demand service searching & providing/consuming service application 110 can use the data stored in the user database 150 to identify previous service locations for the user. Based, in part, on the current location of the computing device 110, the on-demand service searching & providing/consuming service application 110 can use the user data 151, such as the user's home address, the user's place of business, the user's preferences, etc., such as the frequency and recency of previous locations that the user requested services at, to provide recent and/or recommended points of interest to the user. When the user selects one of the entries of a recommended point of interest as a current location and/or pickup location, the on-demand service application 110 can provide the location data 119 to the on-demand service system 170.

Based on the user's current location or service location, the application manager 115 can cause area-specific user interface features 121 to be outputted by the UI component 120. A area that is specific to the user includes the current location (or service location) in which on-demand services can be provided to the user. The area can be a city or metropolitan area in which the computing device 110 is currently located in, can be an area having a predetermined distance radius from current location (e.g., six miles), or can be an area that is specifically partitioned from other areas. Based on the user's area, the application manager 115 can cause area-specific information about the on-demand service to be provided on one or more user interface features 121.

Area-specific information about the on-demand service can be provided, in part, by the on-demand service system 170. As discussed, the on-demand service application 110 can provide location information to the on-demand service system 170 so that the on-demand service system 170 can arrange for a service to be provided to a user (e.g., arrange a transport service or an entertainment provider service). Based on the user-specified area, the on-demand service system 170 can provide information about available service providers (e.g., drivers, or mariachi bands) that can perform the on-demand service in that area.

For example, for a transport service, a transport on-demand service searching & providing/consuming service system 170 can maintain information about the number of available vehicles and passengers, the number of available drivers and passengers, which drivers are currently performing a transport service, which passengers currently looking for transport service, which drivers are ready to pick up users, which passengers are ready to travel or waiting for vehicle, the current location of the vehicles and passengers, the direction and destination of the vehicles and/or users or passengers in motion, etc., in order to properly facilitating the transport service between users and drivers including searching, matching, viewing, selecting, navigating, browsing, accessing, filtering, sorting, bookmarking, sending request or like or status (e.g. I want to travel etc.), requirement (e.g. type of vehicle e.g. rickshaw, number of passengers, shared type of vehicle, vehicle near to passenger and coming on particular road), negotiating, comparing, communicating (queries, rate card, terms & conditions etc.), providing information (schedule, pickup & drop off location, requirement details etc.). Because services can vary between areas, such as cities, the application manager 115 can cause only information pertinent to the user's specific area to be provided as part of the user interface 121.

Using the information maintained about the services, the service providers and prospective or actual consumers, on-demand service searching & providing/consuming service system 170 can provide relevant information to the on-demand service searching & providing/consuming service application 110. Service information 171 can correspond to information about the particular on-demand service that can be arranged by the on-demand service searching & providing/consuming service system 170 (e.g., food services, delivery services, transport services). Service information 171 can include information about costs for the service, available service options (e.g., types of food available, types of entertainment, delivery options), or other details (e.g., available times, specials, etc.). Provider information 173 can correspond to information about the available service providers themselves, such as profile information about the providers, the current location or movement of the delivery vehicles, transport vehicles, food trucks, etc., or the types of vehicles.

Referring back to the example of an on-demand transport service, if the user become online and select one or more types of on-demand services e.g. transport or cab service, the on-demand services, service providers and consumers presenting, searching and facilitating in providing & consuming service system 170 would present nearest or area specific or preferences specific services, service providers. on-demand services, service providers and consumers presenting, searching and facilitating in providing & consuming service system 170 can transmit relevant service information 171 (e.g., cost for the service, promotions in the area) and relevant provider information 173 (e.g., driver information, vehicle information) to the on-demand service application 110 so that the on-demand service application 110 can cause area-specific information to be presented to the user. For any type of on-demand service, the on-demand service system 170 can transmit service information 171 and/or service provider information 173 to the on-demand service application 110.

As an example, a area-specific user interface feature 121 can include a selection interface. The selection interface can include a selection feature that can be accessed by the user (e.g., by interacting with an input mechanism or a touch-sensitive display screen) in order to select one or more service options to search, match, view & request the on-demand service. Based on the user's determined area, type of services, preferences, option selections the selection interface can identify and display only type of service(s) specific service provider(s) to consumers and prospective consumers to service provider(s).

When the user interacts with the multistate selection feature, additional information corresponding to the selected service option can be provided in a area-specific user interface feature 121. In one implementation, the user interface feature 121 can correspond to a summary panel that displays area-specific information about the selected service option. For example, for an on-demand food or dessert service, once a user makes a selection of a type of service (e.g., a type of food or a certain food truck, etc.), the summary panel can display information about the closest available food provider, the average cost for an order, menu details, service provider profile information, or other information that the user can quickly view to make an informed decision.

In another example, for an on-demand transport service, the summary panel can provide area-specific information, such as the estimated time of arrival for pickup (based on the user's current location or pickup location and the current locations of the available vehicles of the selected type), the average fare based on the area (e.g., the average estimated fare can be area-specific because some areas can be more expensive than other areas and/or some vehicle types can be more expensive than other vehicle types), and the capacity of the vehicle (how many riders can fit in the vehicle). In one variation, the summary panel can be provided concurrently with the multistate selection panel so that when the user manipulates the multistate selection feature to select different service options, the content within the summary panel can be dynamically adjusted by the on-demand service application 110 to provide updated information corresponding to the selected option.

Once the user makes a selection by providing a user input 111, the application manager 115 can cause the UI component 120 to provide user interface features 121 that are based on the selected service option. The user or service providers can then view, search, match, sort, filter, communicate, compare, negotiate, book, request for the on-demand service based on the selection. In one example, when the user makes a request, a confirmation user interface feature 121 can be provided by the on-demand service application 110. From this user interface feature, the user can view the details of the request, such as what account or credit card to charge (and can edit or choose a different payment method), provide specific requests to the driver, enter a promotional code for a discount, calculate the price, cancel the request, or confirm the request. As an alternative, the request can be automatically confirmed without displaying a confirmation user interface feature 121.

After the user confirms the request for the on-demand service, the on-demand service application 110 can provide the service request 117 directly to the service provider via on-demand service system or server 170 via the service interface 125. In some examples, the service request 117 can include the service location specified by the user (e.g., the location where the user would like the service to be performed or provided), the user's account information, the selected service option, any specific notes or requests to the service provider, and/or other information provided by the user. Based on the received service request or indication to consume service 117, the on-demand service system 170 can send request or indication to consume service to online or available & nearest or within particular distance or radius specific online or available service provider(s). The on-demand service system 170 can provide additional provider information 173 to the on-demand service application 110, such as the particular service provider who will be fulfilling the service, the service provider's ratings, etc., so that this information can be provided to the user on a user interface 121.

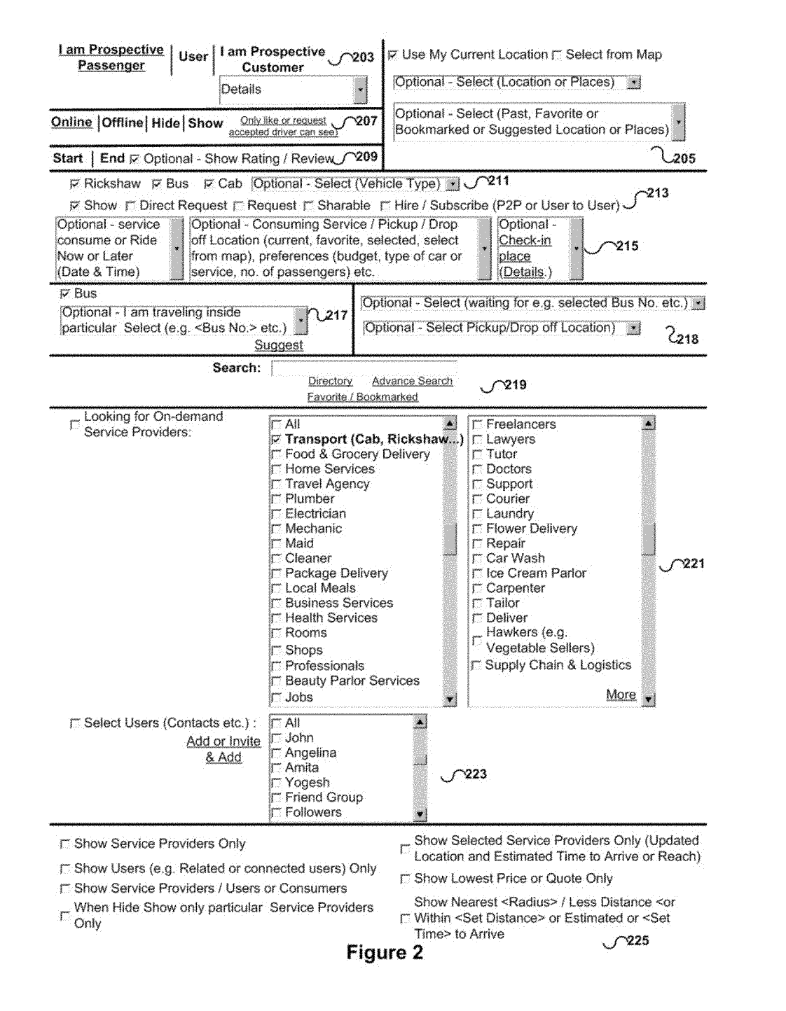

FIG. 2 illustrate examples of user interfaces that are displayed to a user to enable the user to select various options, set role, set status, provide preferences & privacy settings, filter or select type of service providers, provide additional information, and request an on-demand service, provide search keywords, select from directory, according to an embodiment. In an embodiment User can provide or set or select one or more types of role 203 including weather user is prospective passenger i.e. e.g. intend to consume cab service or any other service or user is prospective customer or client or guest or patient or associate or connected or related user. In an embodiment User can provide additional details including what type of product looking, check-in place, budget, preferences, and requirement specification and like. In an embodiment User can provide or set or select one or more types of status 207 of user including online i.e. user want to consume one or more or particular types of on-demand services, offline i.e. now user does not want to consume any on-demand services, hide i.e. user want to hide user icon from map & show only to selected on-demand service(s) provider(s) and wait for arrival of requested or marked on-demand service(s) provider(s) e.g. taxi driver, show i.e. user can again show user icon on map in the event of cancellation of requested or marked service(s) or service provider(s) by user and/or service provider(s) or user want to compare with more service provider(s) or user want to select alternative service provider(s). In an embodiment User can select current location 205 for searching or viewing service provider(s) surround user's current location or service provider(s) within particular distance or radius. In another embodiment user can search, match, select from suggested or check-in location(s) or place(s) 205 or select from past or bookmarked or favorite location(s) or place(s) or select or provide locations from list of locations or input location(s) 205 for consuming services surround that selected location(s) or service provider(s) within particular distance or radius from said selected location(s). In another embodiment user can navigate or scroll map to select one or more location(s) or place(s). In another embodiment optionally user can set various status including start consuming of service and end consuming of service, confirm to reach at particular shop or at particular place or at particular person, going or arriving, reached or arrived, waiting, pending, stop or pause, re-start, near, postponed or delayed, schedule, changed pick-up location or location where user want to consume service(s), cancel and like. In another embodiment at the end of consuming of service or when user set end status or anytime user is presented with ratings and reviews interface 209, so user can rate & provide reviews for particular service(s) or service provider(s).

In an embodiment user can select ride now or consume service now or later as per schedule date & time, provide consuming service or pickup or drop off location including current, favorite, selected, select from map etc., preferences including budget, type of car or service, no. of passengers etc. In another important embodiment user and/or one or more or group(s) of passenger(s) can provide one or more actual or prospective to visit check-in location(s) or place(s) 215 after reaching or drop-off at particular location via vehicle or cab, wherein user(s) can provide check-in location(s) or place(s) 215 while searching, sending indication to consume service, requesting, after request confirm, before pickup, while vehicle or cab arriving or arrived and when trip start or trip end or after drop off from vehicle or cab or any other time. Based on said prospective or actual check-in place(s) information and associate date & time and associate description, details 215, profile or data of said user, profile & data of said check-in place (address, contact information, business hours, profile picture, details of products & services (description, inventory, price, discount, features, services, accepted modes of payments) etc.), prospective or actual amount of money will spend or discount received, preferences, past data, duration spend or check-out time and associate or related information about one or more activities, actions, events, place(s) & transactions provided by user and connected or related users of user and/or databases, system can search, match, determine, provide and present list of places including comparative, competitive priced or suggested by connected users of user, more liked or ranked or better reviewed, better quality, more choices or options, more references, brand or name or fame or more fans, fat or speed or trusted or reliable or certified services, more services, low cost or charges or fees or price or cost or tickets or fares, most visited, availability, less queue, nearest or near location, discounted, better deals or offer, better services, new, alternative, advertised place(s) including movie theater, hotel, bar, restaurant, tourist place, shop, mall, shopping center, ice cream parlor, saloon, hospital, dispensary of particular doctor, vendor or hawker, travel agency, company, manufacturer, seller, retailer, flower seller, on-demand service providers, real estate agency, hall or conventional center, casino, airport, station, bus stop, vehicle or taxi, classes or training center, office, sport complex or center, gym or yoga class, exhibition, fair, banks, ATMs, consultants, professional service providers, auditoriums, school, college, road or route, dieticians, courier, foreign exchange, library, patrol pump, resort, coffee or pizza house, photo studio, money transfer, room rental service provider, club, astrologer & one or more type of products & service providers and associate information to visit to user and/or contextual advertisements. In other embodiment passenger can select one or more place(s) from said list and update or change drop-off location. In other embodiment when said passenger can select one or more place(s) from said list and update or change drop-off location then provide commission or incentive or redeemable points to driver or service provider. In other embodiment charge place owner or administrator including seller or service provider or beneficiary for each selection of each user of said advertised place or each visited user to said advertised place or charge based on amount of purchases or spending of money by said user or passenger(s) at said advertised place(s). In other embodiment enable place advertiser to bid for particular keyword or category specific place or location for enabling said advertised place to present to said contextual passenger(s) in more prominent place or rank in presented contextual list. In other embodiment said driver or service provider or connected users of user or other visited users in past can converse or collaborate or communicate with passengers and based on details from that suggest, guide, solve queries, consult and explain about one or more places or alternative places or spend time on other interesting places to visit than current check-in place. In another embodiment auto determine place of user after drop-off from vehicle based on user's next static or within particular radius auto identified current location or place for particular period of time at particular location or place e.g. person seat inside movie theater or hotel or saloon or restaurant or hotel room or hospital or shop or stand at hawker and like and present contextual list of alternative or comparative, competitive or interesting or suggested places, so user can search, match, select, visit & view information about place(s). In another embodiment based on selection of alternative place or location during trip or while trip or before dropping-off at drop-off location or place from said presented list of places or locations update drop-off location or place, real time update route to reach or arrive and associate estimated or calculated or approximate time, fare and distance to reach or arrive at said selected particular location or place or new or alternative drop off location or place. In another embodiment said user(s) or passenger(s) can rate, rank, weight, details & review on said selected place(s) from said suggested list of contextual place(s) or place suggested driver or visited place. In other embodiment said passenger(s) can further or further to further select alternative or new place to visit e.g. passenger [Y] first select prospective or actual to visit check-in place Hotel [A] then based on suggested list of place provided to user passenger [Y] change or update or select or enter new or alternative place Hotel [B] then after reaching at that place passenger [Y] again change or update new or alternative or other place Restaurant or Hotel [C] and based on that system real-time updates route, fare, time & distance to reach at there.

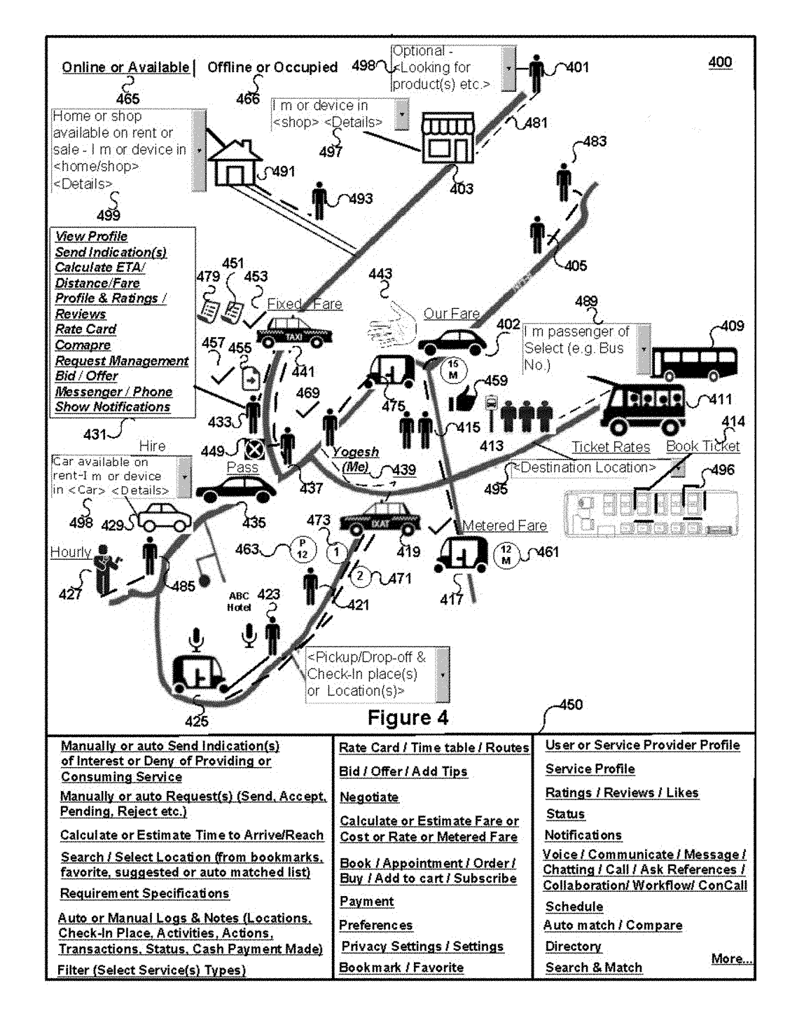

In another embodiment user can select one or more type of on-demand service provider(s) 221 for presenting on map (discussed in detail in FIG. 4) e.g. when user select Transport Service from list 221 then user is presented with more detail or service type specific interface for user selections including e.g. types of vehicles 211 including bus, cab, taxi, rickshaw, sub-type of vehicles 211 e.g. Maruti, Mercedes etc. In another embodiment user can select type of transactions including show only availability of service provider(s), send request, send only indication of interest of consuming particular service to one or more selected or preferred or auto matched service provider(s), directly send request to one or more selected or preferred or auto matched service provider(s), select only sharable vehicles, hire vehicle from user, select ride now or ride later i.e. as per user's schedule date & time, provide pickup or drop off location(s) including current location, select from list or search & select location(s) or select from past or favorite or check-in location(s) or select from map 213 and like. In other embodiment based on one or more prospective check-in locations or places, system can present one or more advertisements or alternative place(s) to check-in place information provider user(s).

In another important embodiment user or prospective bus passenger can identify arrival of particular number of bus or bus going to user's particular pickup location to particular drop of location within particular distance and duration (i.e. estimated time to arrival) based on selecting preferred bus number or select or provide drop of location 218, wherein server identifies nearest bus from said prospective bus passenger based on another users availability inside nearest bus from said prospective bus passenger based on status and current location of said another user(s), wherein said another user(s) already set his availability in said particular number of bus i.e. set status “I am traveling in <particular bus number>” 217.

In another important embodiment on-demand service consumer or user or prospective passenger can search, match, filter, select from list(s), browse directory 219 for identifying, viewing on map (discussed in detail in FIG. 4), comparing, selecting, negotiating, communicating, requesting, transacting with one or more on-demand service provider(s) for consuming one or more service(s).

In another embodiment user can select one or more or group(s) of contacts or connections 223 who are reaching or arriving to user or user is reaching to them, so user or said selected connected users of user can know real-time updated estimated or approximate time & distance to reach.

In another embodiment user can select one or more preferences, settings or privacy settings and filters 225 including show only service provider(s), show only selected connected or contacts user only on map, show one or more types of service providers as well as contextual customers or prospective consumers of said services of said service providers, show only selected or marked or requested or preferred or confirmed service provider(s) only, show only selected service provider(s) only including show estimated time to arrive and real-time show & highlight updated location of said selected service providers from current or selected location of user or consumer, show filtered service providers including show lowest cost or price or fees or fare or quote related service providers, show nearest or within particular distance or within particular radius related service providers and like (discussed in detail in FIG. 4).

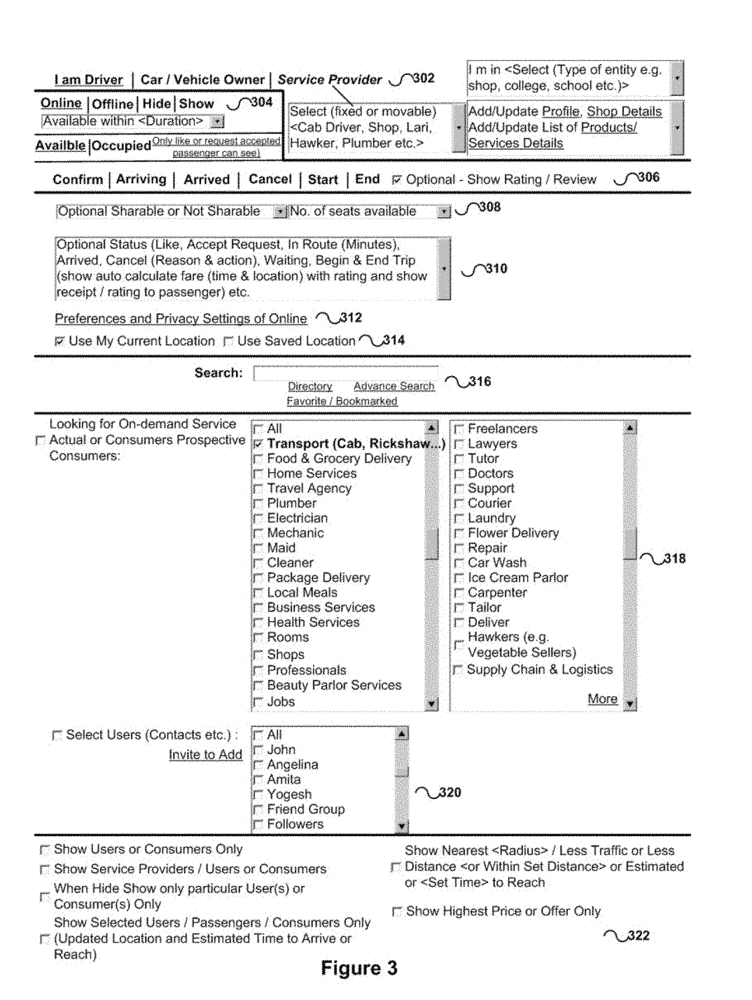

FIG. 3 illustrate examples of user interfaces that are displayed to a service provider to enable them to select various options, set role, set status, provide preferences & privacy settings, filter or select type of prospective consumers, provide additional information, provide search keywords, select from directory, according to an embodiment. In one embodiment service provider can set one or more types of role 302 including one or more type of service provider(s) e.g. driver, car owner, taxi dispatching service or taxi company, related or connected user of particular user(s), shop owner and like. In another embodiment service provider can fix e.g. shop or movable e.g. car, electrician etc. Service provider can provide additional details including service provider's profile, service profile, and information about services, type of entity, list of available products and services, information about products and services and like. In another embodiment service provider can set various status including online i.e. service provider is available for service consumers or customers or passengers or users, offline i.e. service provider is not available or occupied. In another embodiment service provider can provide availably schedules or timings or available within particular duration, hide status i.e. hide service provider or service icon from real-time updated map in the event of when service provider accept or confirm or start providing of services or waiting confirmation from one or more service consumers, show status i.e. in the event of cancellation by service consumer service provider can set “show” status and enable him or icon of service or service provider to show on map again 304.

In another embodiment service provider can set various status including confirm request, send indication, reject or deny, arriving, arrived, cancel, start, end, postponed, delay, pending, waiting, available within particular duration and like 306. In another embodiment service provider can enable and provide ratings and reviews for one or more consumers of services 306.

In another embodiment service provider can set type of service including e.g. sharable vehicle, number of seats available and like 308. In another embodiment service provider can provide additional information including rate card, expert answer service, payments mode(s) accepted, verified services certificate, references, provide fare, provide receipt and like.

In another embodiment service provider can search, match, filter, browse, select from directory, select from bookmarked or favorite list and select type of service consumers 316.

In another embodiment service provider can select related type of service specific actual or prospective consumers of services 318.

In another embodiment service provider can create group and add him/her or search, match, filter, select & add one or more other service providers or invite and add service providers. In another embodiment service provider can join or exit or remove from one or more service providers group(s) 320.

In another embodiment service provider can set, apply, select & provide online availability specific preferences and privacy settings indulging schedule or colander of availability date & time, number of service providers, non-availability dates & timings, dynamic rates or fares or fees or salary or charges or costs or prices at particular dates & timings or duration or ranges of date & time.

In another embodiment service provider can use current location for finding prospective consumers surround him/her or use saved one or more location e.g. shop location, location of user inside shop 314.

In another embodiment user can select one or more preferences, settings or privacy settings and filters 322 including show only users or customers or prospective consumers or clients or guests or patients or passengers & like, show only selected connected or contacts user only on map, show one or more types of service providers as well as contextual customers or prospective consumers of said one or more types of services of said service providers, show only selected or marked or requested or preferred or confirmed prospective consumer(s) only, show only selected prospective consumer(s) only including show estimated time to arrive and real-time show & highlight updated location of said selected prospective consumer(s) from current or selected location of user or service provider(s), show filtered prospective consumer(s) including show highest provider of cost or price or fees or fare related prospective consumer(s), show nearest or within particular distance or within particular radius related prospective consumer(s) and like (discussed in detail in FIG. 4).

FIG. 4 illustrate multiple examples or embodiments of user interfaces that are displayed to a user to enable the user to view preferred, online, available, interested to provide service(s) & nearest or within particular radius service providers and/or enable service provider to view preferred, online, interested to consume service(s), & nearest or within particular radius users or prospective consumers and enable to search, match, select, send or accept or reject request or indication of interest to provide or consume service(s) to one or more auto matched or selected or preferred service providers or users or prospective consumers, view estimated or updated time to arrive or reach of one or more preferred or selected service providers or users or prospective consumers, view updated current location of service providers or users, view or set various types of status, request an on-demand service, present one or more contextual user actions & enable take one or more user actions, according to an embodiment.

In one embodiment user interface 400 enables user e.g. User [Yogesh] 439 including prospective passenger or customer or consumer to indicate interest of consuming on-demand service(s) via tapping or touching or clicking or selecting “Online” button or link or icon or control 465 or activating or setting status as “Online” which means user is intended to consume on-demand service(s) of one or more type(s) of service provider(s) including transport or vehicle or cab service. In one embodiment user interface 400 enables service provider e.g. service provider 441 including e.g. car driver to indicate interest of providing on-demand service(s) via tapping or touching or clicking or selecting “Online/Available” button or link or icon or control 465 or activating or setting status as “Online” which means service provider is intended to provide one or more type(s) of on-demand service(s) to one or more user(s) including transport or vehicle or cab service. In one embodiment user interface 400 enabling user including prospective passenger or customer or consumer to indicate that user already consumed on-demand services or user now does not want to consume or at present does not no want to consume or request or search on-demand services via tapping or touching or clicking or selecting “Offline/Occupied” button or link or icon or control 466 or activating or setting status as “Offline/Occupied”. In another embodiment user interface 400 enabling service provider(s) including e.g. cab driver to indicate that at present service provider(s) is providing on-demand services to particular passenger or consumer or client or user or at present does not want to provide or accepting of any service request or search on-demand service consumers via tapping or touching or clicking or selecting “Offline/Occupied” button or link or icon or control 466 or activating or setting status as “Offline/Occupied”.

In an embodiment after activating of “Online” status of user e.g. User [Yogesh] 439, user e.g. User [Yogesh] 439 can view on user interface or map 400 one or more types of service provider(s) icons including cabs, cars, buses, rickshaws, electrician, shop & like and associate contextual user actions 431, 445, 407 & 450, wherein said presented service providers are registered with system and now have online status and are available for prospective service consumers. In an embodiment user can view online, available and nearest service providers e.g. cabs, buses, rickshaws including service providers surround use's current location or within particular radius 400, so user come to know who are at present available to provide particular type of service to user. In an embodiment user can also view estimated or approximate time and distance to reach or arrive by each service provider or reach by user to particular service provider or reach to particular movable other user. In another embodiment user interface 400 also suggest nearest or competitive or lowest priced or fare service providers rank wise e.g. 473 & 471, so user can easily determine who is very near as well as who provide lowest fare though they are far from other service provider.

In another embodiment user interface 400 enables user to select one or more service provider(s)′ icon(s) from plotted map based on updated locations and status of service providers and users or consumers e.g. prospective passengers and enable to access, use, select one or more associate contextual user actions including view details about or profile of one or more selected or preferred or searched or matched or suggested service provider(s) and service(s), read rate card, fixed rate or metered rate, start communication with them for asking queries, negotiations, terms & conditions, rates, extra costs of toll or driver, type & capacity of vehicle, view ratings & reviews of other users of network or connected users of user, send indication of consuming service e.g. User [Yogesh] 439 sends indication of consuming service 443 to rickshaw 475 indicating that User [Yogesh] 439 wants to travel by said rickshaw 475. E.g. Rickshaw 475 can send indication 439 to arrive at user's current location e.g. current location of User [Yogesh] 439, so User [Yogesh] 439 can come to know that Rickshaw 475 is manually confirm and arriving or arrived to User [Yogesh] 439, so User [Yogesh] 439 can travel by said Rickshaw 475. In another embodiment system presents or provides updated location of and estimated time & distance of Rickshaw 475 to User [Yogesh] 439, so User [Yogesh] 439 can come to know that Rickshaw 475 is arriving and reach within particular time to him.

In an embodiment user e.g. user 433 can prepare request 455 & send request 451 to selected service provider e.g. 441, after reviewing request 451 service provider 441 can accept or reject request e.g. service provider 441 accepts request 451 of user 433 and send indication of acceptance of request 457 to user 433 and send indication of rejection of request 449 to user 437 based on suggested or estimated or calculated or approximate time & distance to reach said requested passenger users 433 & 437 and/or based on user ratings and/or based on estimated fare and/or based on offer of best price or fare or one or more other factors. In an embodiment and example service provider 441 after acceptance of request of user 433 can set or provide status including confirm, arriving, arrived, starting of trip and ending of trip. In an embodiment user e.g. user 433 can provide requirement specification to e.g. service provider 441 including pick up or drop off location, type or brand of vehicle or car, number of passengers, ride now or ride later as per schedule, provide bid or offer or competitive or highest far, budget and like. In an embodiment user e.g. user 433 can also set or provide status including confirmation of, arriving of, arrived particular or selected or requested service provider or vehicle, starting and ending or cancellation of trip and like. In an embodiment system monitors, tracks, stores, updates & logs one or more types of activities, actions, events, transactions, locations, communications, notifications, updates, interactions, searching, navigations & status of users and service providers. In an embodiment user interface facilitating user and service provider to monitor, track, input, select, edit, stores, updates & logs one or more types of activities, actions, events, transactions, locations, communications, notifications, updates, interactions, searching, navigations & status of user or service provider. In an embodiment user e.g. user 433 can directly make cash payment of fare at the end of trip to e.g. service provider 441 or directly pay to said service provider 441 without any cuts of intermediary commission via one or more payment methods accepted by said e.g. service provider 441 including one or more types of payment modes including pay via credit card, debit card, net banking, digital wallet currency, coupon, redeemable points, points, and any other types of available payment modes which can integrated by system and accepted by said service provider 441.

In an embodiment user e.g. user 433 can select one or more service provider icons on map and can ask for fare, compare, bid, offer, chat, send message to one or more service providers, ask for quires, send indication of interest to consume service, calculate estimate fare, view rate cars & profiles, view ratings & reviews, send request, book service, make payment, bookmark, set status, calculate or view estimated or approximate time & distance to arrive & like. In an embodiment system can limit sending of indication of interest to consume service to set or particular number of service providers.

In an embodiment system can limit presenting of particular or set number of service providers to each user or particular type of user.

In an embodiment user interface 400 can present one or more types of contextual advertisements or listing of products & services at one or more prominent places or types of places on user interface 400 including text, link(s), image(s), multi-media, video(s) & voice advertisements based on user(s) and service provider(s)'s location(s), check-in place(s), profile, user data, one or more types of activities, actions, events, transactions, locations, connect ions, communications, notifications, updates, interactions, searching, navigations & status of users and service providers.

In an embodiment after providing or consuming of on-demand service(s) user or service provider can provide ratings and reviews to each other, so system can rank based on ratings, likes, dis-likes, reports and reviews and other user can read or view ratings, likes, dis-likes, reports and reviews of other users and can determine opting of service(s).

In another embodiment system can limit sending, receiving, accepting, rejecting, denying and cancelling of request and indication of interest of consuming or providing of on-demand services for users as well as service providers.

In other embodiment 3rd parties providers and developers can integrate other applications or web services with system via Application Programming Language (APIs), SDK & web services and/or provide matchmaking, searching, filtering, sending or receiving, assigning & routing requests or indications, administration, setting various status as per tasks or workflow, sending or viewing or analyzing requirement specifications, due diligence, scheduling, planning & publishing requirements, screening, verification, validation, reference, interviewing, hiring, appointing, managing, suggesting, presenting, certifications, referring, negotiations, comparison, ranking, ratings & reviewing, communicating including calling & messaging, collaborating, updating profile, bookmarking or cavorting, like, dis-like & reporting, billing, accounting, metering, bidding, offering, discounting, providing payment modes & services, surveying, payments, delivery, booking, receive & provide appointments, subscribing services, selling, advertising, marketing, promotion, e-commerce, ordering, accepting & processing orders, consulting, routing, expert services of/to/for/with users and/or one or more types of one or more or group(s) of on-demand service providers.

In other embodiment user interface 400 enables provider user(s) or geo-location enabled device 411 to help other users 413 in finding nearest bus (government or private etc.) or other vehicle(s) or train(s) or boat(s) etc. for particular rotes or destinations or drop off location in which provider user(s) 411 is/are traveling or conducting or driving by enabling him/her/them to set provider user's 411 current status to “I am or geo-location enabled device travelling in particular”<Bus Number> or <Route> or <Location> 489. So based on searching user's 413 current or selected or drop off location(s) 495 and provider user's 411 current location(s) and status 489 i.e. bus number, rotes, provided or pre-stored location information about various bus stops system can identifies & matches & presents bus(es) e.g. 411 for searching users 413 or user's at particular location(s) 413 (i.e. current location or selected location of searching user 413) who wants to travel at particular provided location(s) 495 by bus. In other embodiment provider user(s) 411 are also enables to provide other types of information to searching or waiting user(s) 413 including estimated time to reach at searching user and/or destination of searching user, approximate distance to reach at searching user and/or destination of searching user, ticket fare, traffic, availability of seats, routes, alternatives or comparisons, type & condition of bus or vehicle, ratings & reviews and like. In other embodiment said user inside bus 411 drop down in particular bus stop and no any other user presents inside bus 411 then determine bus 411 availability to waiting passengers at next stop based on last seen location and route, speed, traffic data related to bus and calculate or estimate approximate real-time updated time & distance to reach at next stop. In another embodiment user inside bus can along with bus number and destination location also provide or select seat number e.g. select seat from pre presented seat number display 496 or provide row or column of seat, so standing passenger can approximately come to know that which seat(s) is/are available at or before which bus stop or after what updated time and distance. Based on current location, destination or drop-off location, bus number, bus route database, traffic information user interface 400 can present on map approximate real-time updated time and distance when particular seat(s) or particular number of seat(s) or particular row or column specific seat(s) is/are available for other passengers. In another embodiment prospective passenger or user from anywhere or passenger inside bus can provide or select bus number or bus and destination or drop-off location and can book ticket(s) 414 from user interface 414. In another embodiment user as well as conductor or driver or ticket checker can view receipt or notification of booked tickets with unique identifier number in mobile device, so conductor driver or ticket checker or other automated ticket checker device (e.g. unique ticket booking number scanner (via software or device) can match scanned unique ticket booking numbers from user device with unique ticket booking number stored on sever database) can check valid numbered booked tickets. In another embodiment based on current & drop-off location user interface 400 also provide alert or notification to passenger before arriving of destination or drop-off location or particular bus stop.

In other embodiment user interface 400 enables provider user(s) or geo-location enabled device inside shop or mall or any physical structure or static structure e.g. online or open or available or started museums, exhibitions, sellers, hotels, restaurants, daily discounted deals providers, colleges, schools, street hawkers, vegetables sellers, service providers, patrol pump & like 403 to helps searching users to search nearest, online (i.e. open, available, presented users or sellers or salesmen etc.), available & updated list of products and services and associate updated or current discount, information, offers, events, presentation, exhibition by providing current status of user inside shop 403 as “I am or geo-location enabled in particular”<shop or department of shop> <details and links>, so based on location of said user inside shop 403 and associate said status, system can match and provide nearest shops and information about shops, products & services to searching user e.g. 401 who are looking or searching for particular products and/or services and or provide available physical products surround searching user's 401 current or selected location. In an embodiment system also provide estimated time, distance to reach there and in an embodiment provide turn by turn directions to reach there. In an embodiment user interface also updates & presents or highlight routes and current estimated time & distance to reach there.

In other embodiment user interface 400 enables user(s) or geo-location enabled device inside particular home or apartment or hotel or any type of infrastructure e.g. 491, who wants to rent available room 491 to other users e,g. 493, to set status to “online” i.e. room available to book for other users or rom searching users and provide associate details. Based on said availability status, information and current location of said available room, use interface 400 enables room or apartment etc. searching user e.g. 493 to view matched nearest available room(s) e.g. 491 as per their requirement specifications. In an embodiment system also provide estimated time, distance to reach there and in an embodiment provide turn by turn directions to reach there. In an embodiment user interface also updates & presents or highlight routes and current estimated time & distance to reach there.

In other embodiment user interface 400 enables user(s) or geo-location enabled device inside particular car or any type of vehicle including rickshaw, cycle, bike, available car of any car or vehicle owner for particular period at parking or movable car or vehicle e.g. 429 & 435, who wants to rent available car or one or more types of vehicle 429 to other users or car or vehicle searching users e,g. 437, to set status to “online” i.e. car or vehicle available to book or hire for other users or searching users and provide associate details. Based on said availability status, information and current location of said available car or vehicle, use interface 400 enables car or vehicle searching user e.g. 437 to view matched nearest available car(s) or vehicle(s) e.g. 429 & 435 as per their requirement specifications. In an embodiment system also provide estimated time, distance to reach there and in an embodiment provide turn by turn directions to reach there. In an embodiment user interface also updates & presents or highlight routes and current estimated time & distance to reach there.

In other embodiment user interface 400 based on current location and connections enables user(s) e.g. 405 and other user(s) or selected user(s) in contacts including connected or related or contacts users added by user or connected user or joined to particular group(s) e.g. 483 to find each other. In an embodiment system also provide estimated time, distance to reach or arrive at particular location and in an embodiment provide turn by turn directions to reach there or meet each other. In an embodiment user interface also updates & presents or highlight routes and current estimated time & distance of both or one or more or group(s) of user(s) to reach at particular location or meet each other.

In other embodiment system monitors, tracks, stores & updates online status and available status with date & timestamp and waiting time duration to identify who is online and available first and rank service providers e.g. cab drivers as per waiting time of looking for prospective customers.

In other embodiment user interface 400 enables online, available, nearest or available within particular radius one or more types of service provider(s) e.g. 427 and/or one or more types of matched service consumer user(s) e.g. 485 to identify, view, search, match, compare & select and communicate, send or accept or reject or cancel request, send indications, bid, make offer, make payment, provide ratings & reviews, subscribe or hire or book or hire for particular date or time or as per schedule and negotiate with each other. View profile, service profile of each other. In an embodiment system also provide estimated time, distance to reach or arrive at particular location and in an embodiment provide turn by turn directions to reach or arrive at particular or current location or meet each other. In an embodiment user interface also updates & presents or highlight routes and current estimated time & distance of both or one or more or group(s) of user(s) to reach at particular location or meet each other.

In other embodiment user interface 400 enables users to share service providers or share service like taxi. First individual or group of passenger(s) e.g. 415 can identify particular vehicle e.g. taxi 402 and can set status to “sharable” and based on location, number of available seats and status system identifies other interested prospective passengers 415 within particular radius or distance and their locations and enable taxi 402 to pick up them. In an embodiment system also provide estimated time, distance to reach at particular locations of remaining passengers and in an embodiment provide turn by turn directions to reach at particular locations of remaining passengers. In an embodiment user interface also updates & presents or highlight routes and current estimated time & distance of each remaining passengers waiting at particular locations.

In other embodiment system identifies, define, suggest, present on digital map and provides pickup locations for picking of vehicle e.g. cab or taxi or points or stops or stations 463 to users and service providers for meeting with each other based on activities, actions, events, transactions, locations, daily preferred or defined routes, date & timings & logs or history of users and service providers data including number of passengers picked up at particular locations and number of passengers drop off at particular locations within particular date and/or time or duration or ranges, fare paid at particular locations, average waiting time to find out passengers or service consumers, number of consumers subscribed one or more types of services at particular location(s) and total amount paid for services within particular duration and like.

In other embodiment users can collectively or collaboratively or in-group or aggregately subscribe on-demand services of service providers or one or more group(s) of services of one or more group(s) or network(s) of service providers based on per year, month, week, day, hour(s) & minute(s), particular date & timings, ranges of dates and timings, number of days or ranges or as per schedule at one or more locations. E.g. collaborative sharing enabled or registered to particular group of network or route network or location network users and/or service providers can pay or receive fare based on per day rate, so service provider e.g. cab driver will get minimum fixed fare per day and collaborative sharing enabled or registered users who are passengers of said taxi can pay said per day fare divided by number of passengers or based on total distance they traveled. System automatically and continuously assigns available service provider(s) or cab(s) to said collaborative sharing enabled or registered prospective passenger(s) or service consumer(S) or user(s).

In other embodiment user interface 400 enables user and/or service provider to select or tap on one or more icons on user interface or map or select via voice or any other available manner and access associate contextual or dynamically presented relevant or contextual options or user actions 450 or menu 431 including enable to send indication of interest to consume or provide or confirm one or more types of on-demand services of one or more on-demand service providers or send indication of denial or rejection or cancellation of providing or consuming of on-demand service(s) of on-demand service provider(s), send, accept, confirm, reject request and, make request as pending, calculate or estimate time & distance to arrive or reach, search or select location(s) from bookmarks, favorite, suggested or auto matched list, manage requirement specifications including edit, update, send, receive, view, analyze, compare, sort, filter, rank, share, monitor, track, assign & like, auto or manually logs & update notes including locations, check-ins, activities, actions, events, transactions, status, accounting, metering, subscriptions, payments made including cash payment, payment via credit or debit card or net banking or any other payment modes, filter user interface or dynamically updated map based on one or more types of selected service(s) or service provider(s), sub-type of service(s) e.g. type (e.g. bus or cab or rickshaw) or brand (e.g. Marui, Mercedes) of vehicle, category or sub-category or grade or price or rate or fare or rank of service(s) or service provider(s), provide, update & view rate card, accepted modes of payments, pricing models, subscription models, bid or provide offer or redeemable points or discounts for providing or consuming service(s), negotiate with provider or consumer of selected service(s), calculate or estimate approximate fare or cost or rate of consuming or providing of selected service(s), book or take appointment of service provider(s) or order or buy or add to cart or subscribe or hire or rent service(s) or service provider(s) or product(s), manage payment(s) including provide payment information, select accepted payment modes by service provider, view accounting, billing, charges, commission, metering, subscriptions & payment logs, manage one or more types of preferences including presentation preferences (discussed in detail in FIG. 2-3), budget ranges, scheduling, payment mode, show ratings & review interface after finish of consuming service(s) & like, manage, provide, set, apply, select & update privacy settings & other types of settings including show within particular distance or radius specific users or prospective customers or service providers, show particular number of users or prospective customers or service providers, show or hide full or partial user profile, enable turn by turn location, enable or disable or allow to access one or more or group(s) of selected user connections or contacts, allow or not-allow to view check-in places and user logs or one or more type(s) of user data, bookmark or favorite or like or dis-like or block or show/hide one or more users or prospective customers or service providers or one or more type(s) of service(s), manage, provide, share, update & view user profile or service profile or service provider profile, manage, provide, view, update, share ratings, ranks, weights, grades, comments, suggestions, feedbacks, notes, logs, reviews, likes & dis-likes, manage, provide, select, set, apply, notify, share, update one or more types of role(s), manage, provide, select, tap, set, apply, notify, share, update one or more types of status, manage, provide, select, update, send, share, publish, advertise, receive, & view one or more types of notifications or messages or alerts, select one or more types of communication, messaging, chatting & calling applications, services & interfaces to communicate & collaborate with users and/or service providers including chat, instant messenger, email, phone call, VOW call, SMS, MMS & like, schedule providing or consuming of one or more types of on-demand services by user(s) or service provider(s), compare one or more or group(s) or one or more type(s) of selected service(s) or service provider(s) or service consumer(s) or user(s) or passenger(s) or customer(s) or client(s), wherein compare based on rank, ratings, number of likes or dis-likes or reports, fare price or rate, cost, charges, discounts or offer or redeemable points or deals or bid provided, subscriptions, distance, availability timings or duration, provided one or more types of services or features, references, experience, nearest availability, relationships, affiliations, accepted payment modes, terms, rules & conditions, certificates, verification types, quality, brand, urgency & like, search, match, navigate, browse, select & view from categories or sub-categories directory of service providers and prospective on-demand service(s) consumers and access associate contextual or dynamically presented type(s) of service(s) or service(s) provider(s) or user(s) or prospective consumer(s) specific relevant options or user actions or interfaces, enable to search & match service providers or services or prospective matched or contextual customers based on keywords, Boolean operators, rules & conditions and subject or type(s) of service(s) or service(s) provider(s) or user(s) or prospective consumer(s) specific advance search options.

In other embodiment users and/or on-demand service providers can send or select voice and/or video and/or text and/or image messages to each other for requesting, querying, indicating of interest of consuming and/or providing on-demand services, like, dis-like, communication, listen or view information including user or service or service provider profile, notifications, status, requirement specifications, preferences, offers, bids, discount, book, order, purchase, make payments, subscribe, suggestions or feedbacks, ratings & reviews, search, provide or listen or view pick-up or drop of location or service providing or consuming location(s), connect & communicate with references, rate card, service details, terms & conditions and like.

In other embodiment automatically determine various status or user including determine looking for or interested in providing or consuming service or availability based on “Online status” of user or service provider and one or more selections of service provider(s) by prospective service consumer(s) or prospective service consumer(s) by service provider(s) or ending trip or providing of service status or offline or occupied status, determine arriving or reaching or confirm status based on location or route directed towards current or selected location(s) of service consumer(s) or service provider(s), determine arrived or reached based on near current or selected or exact location of service consumer(s) or service provider(s), determine starting location based on location of both requested or interest showing service consumer(s) or service provider(s), determine ending of location based on different location after said same location of both said service consumer(s) or service provider(s), determine cancel status based on identify static location or offline status of service consumer(s) and/or service provider(s) or sending or accepting of other users request by service consumer(s) or service provider(s) or starting of providing of service to other users by service provider(s), determine in-process status based on starting and ending of status.

In other embodiment provide rank-wise list of available service providers based on online status, availability status, calculated or estimated approximate price or fare or rate, real-time updated distance to arrive or reach, real-time updated calculated or estimated approximate time or duration to arrive or reach, ratings, preferences, calculated or estimated approximate time to reach at destinations or drop-off location or providing service(s) and like.

In other embodiment monitoring, tracking & storing each user's and/or service provider's pickup and drop-off locations or service consumption or service providing locations with date & time, check-in or check-out place with date & time, traffic at or from-to particular location(s) or place & associate details, duration and description after reaching or dropping off from vehicle, associate route, actual time & distance to arrive or reach, fare or charges paid or charged and based on that determine or provide best or competitive or comparative current route(s) to reach or arrive at particular location or place at particular date & time, actual time & distance to currently reach at particular location(s) or place(s) at particular date & time and actual or best current fare required to pay to reach at particular location or place via particular vehicle brand or type, wherein said monitored or tracked data provided by services providers and/or users and/or automatically identified, calculate & tracked based on status, locations, date & time, fare database.

In another embodiment dispatchers or intermediary or agent or 3rd parties service provider can take phone bookings, booking form with Google map, schedule trips, comparing, match making based on fares, quality, requirement, duration to reach at destination, service type, speed etc., negotiating, biding, view ongoing trip(s) in real-time, assign trips to drivers, auto dispatch of taxis or assign driver manually, manage taxi locations, take recurrent bookings, track payments and auto email taxi fare receipts after completion of the trip, view and monitor trip history, passenger details, driver details, taxi details, transactions, payment mode and status based on per booking charges from passenger and/or driver and not on fare transaction

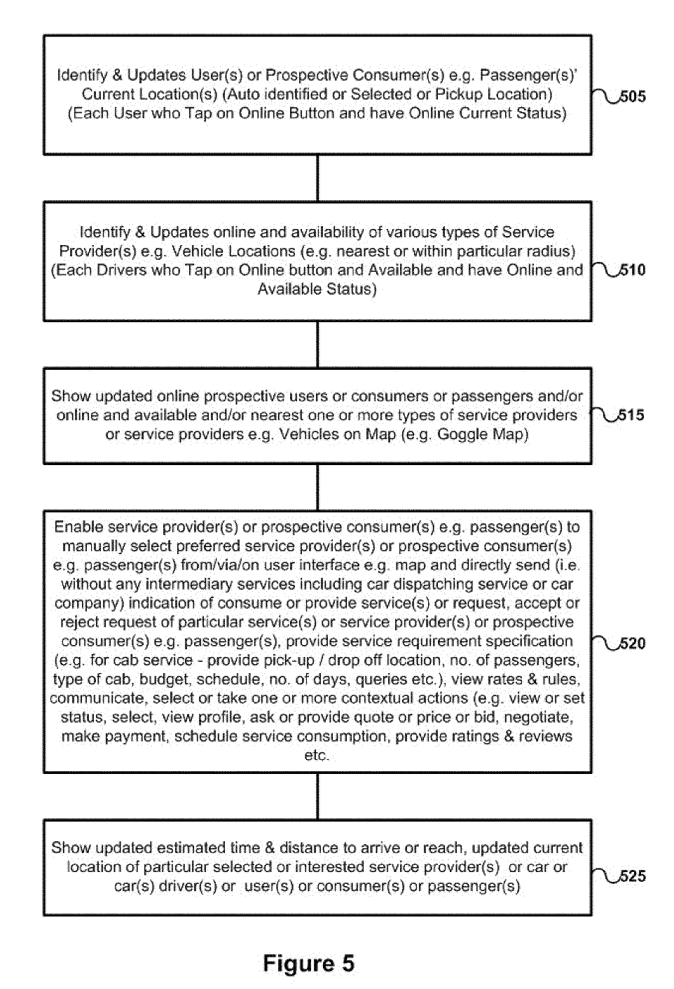

FIG. 5 illustrates an example method for enabling a user to view, search, and match, select & directly request on-demand services without any intermediary (e.g. intermediary service including dispatching service provider or car service company) using a computing device, according to an embodiment.

System identifies & updates user(s) or prospective consumer(s) e.g. passenger(s)′ current location(s) including auto identified current location or selected or pickup location and identifies & updates each user's current status as “online” 505; System also identifies & updates online and availability of various types of service provider(s) e.g. vehicle locations (e.g. nearest or within particular radius) based on each drivers current status i.e. “Online” and “Available” status for providing on-demand service(s) to prospective consumers or searching or viewing users via tapping on “Online” status button or “Available” status button 510. User interface or dynamically presented or real-time updated map 400 shows updated online prospective users or consumers or passengers and/or online and available and/or nearest one or more types of service providers or service providers e.g. show nearest vehicles on map surround user's or service provider's current or selected location (e.g. Goggle Map) 515; Enabling service provider(s) or prospective consumer(s) e.g. passenger(s) to manually select preferred service provider(s) or prospective consumer(s) e.g. passenger(s) from/via/on user interface e.g. map and directly send (i.e. without any intermediary services including car dispatching service or car company) indication of consume or provide service(s) or request, accept or reject request of particular service(s) or service provider(s) or prospective consumer(s) e.g. passenger(s), provide service requirement specification (e.g. for cab service—provide pick-up/drop off location, no. of passengers, type of cab, budget, schedule, no. of days, queries etc.), view rates & rules, communicate, select or take one or more contextual actions (e.g. view or set status, select, view profile, ask or provide quote or price or bid, negotiate, make payment, schedule service consumption, provide ratings & reviews etc. 520; dynamically present or show real-time updated estimated or calculated approximate time & distance to arrive or reach, updated current location of particular selected or interested service provider(s) or car or car(s) driver(s) or user(s) or consumer(s) or passenger(s) 520.

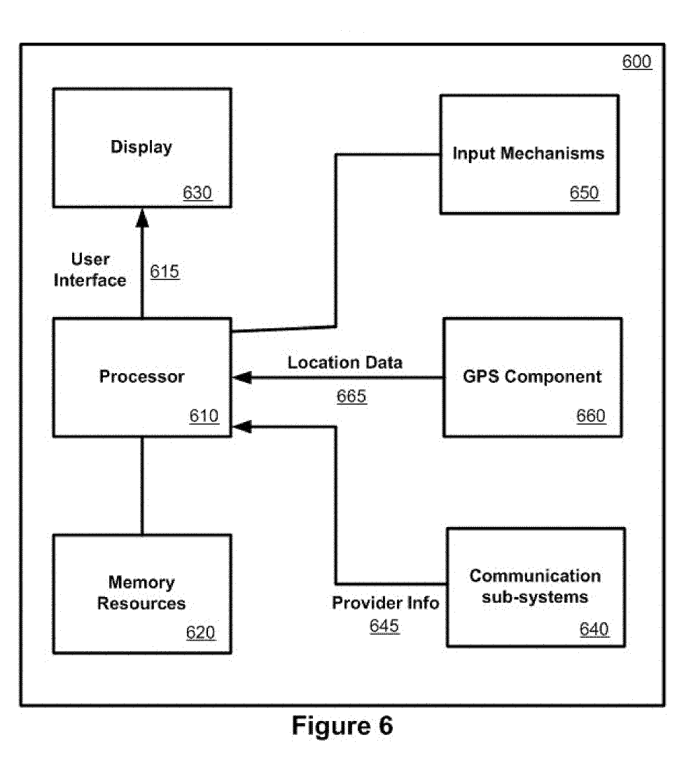

FIG. 6 is a block diagram that illustrates a mobile computing device upon which embodiments described herein may be implemented. In one embodiment, a computing device 600 may correspond to a mobile computing device, such as a cellular device that is capable of telephony, messaging, and data services. Examples of such devices include smartphones, handsets or tablet devices for cellular carriers. Computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component) 660. In one example, at least one of the communication sub-systems 640 sends and receives cellular data over data channels and voice channels.

The processor 610 is configured with software and/or other logic to perform one or more processes, steps and other functions described with implementations, such as described by FIGS. 1-5, and elsewhere in the application. Processor 610 is configured, with instructions and data stored in the memory resources 620, to operate an on-demand service application as described in FIGS. 1-5. For example, instructions for operating the service application to display various user interfaces, such as described in FIGS. 2-4, can be stored in the memory resources 620 of the computing device 600. In one implementation, a user can operate the on-demand service application so that location data 665 can be received by the GPS component 660. The location data 665 can be used by the application to present user interface features that are made specific to the current location of the computing device 600.

The location data 665 can also be provided to the on-demand service system using the communication sub-systems 640. The communication sub-systems 640 can enable the computing device 600 to communicate with other servers and computing devices, for example, over a network (e.g., wirelessly or using a wireline). The location data 665 can be communicated to the on-demand service system so that when the user requests the on-demand service, the system can arrange the service between the user and an available service provider. The communication sub-systems 640 can also receive provider information 645 (such as location and/or movement information of drivers in real-time) from the on-demand service system and transmit the provider information 645 to the processor 610 for displaying service provider e.g. driver data on one or more service consumer or user interfaces 615.

The processor 610 can cause user interface features to be presented on the display 630 by executing instructions and/or applications that are stored in the memory resources 620. In some examples, user interfaces 615, such as user interfaces described with respect to FIGS. 2-4, can be provided by the processor 610 based on user input and/or selections received from the user. In some implementations, the user can interact with the touch-sensitive display 630 to make selections on the different user interface features 615 so that area-specific information (that is based on the user selections) can be provided with the user interface features 615. While FIG. 6 is illustrated for a mobile computing device, one or more embodiments may be implemented on other types of devices, including full-functional computers, such as laptops and desktops (e.g., PC).

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

Those skilled in the art will appreciate that computer system 600 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

What is claimed is:

1. A computer implemented method for directly user to driver arranging transport located at different locations, the method being implemented by one or more processors and comprising the steps of:
(a) providing interface for self-service listing of one or more drivers or vehicles with details or receiving request to list one or more drivers or vehicles with details;
(b) registering or make listed drivers or vehicles available including verifying by admin, provided details of vehicle and driver before making them register or available to access;
(c) enabling a user at a first geographic location to make a request for transport, wherein request comprise at least one of a pick-up region or a drop-off region;
(d) receiving a transport request from a user, the transport request specifying at least one of a pick-up region or a drop-off region;
(e) generating, using a processor, map based on one or more criteria or parameters or rules including pick-up region or a drop-off region;
(f) presenting generated or updated map, wherein map comprise selectable graphical representation or indication or icon(s) of one or more types of one or more vehicles and each presented vehicle associated one or more types of details with user control including menu for enabling viewing user to take one or more actions including book vehicle, communicate with driver to ask query, negotiate & add tips, view verified or unverified icon or badge, ratings, fare provided or updated by driver or owner, fare estimates or cost based on pick-up region or a drop-off region, distance of vehicle from pick-up region and time to arrive of vehicle at pick-up region;
(g) enabling user to filter presented graphical representation or indication or icon(s) of one or more types of one or more vehicles on generated or updated map, wherein filter based on type of vehicle, close proximity, budget, no. of seats or space availability, ratings, verified or un-verified;
(h) enabling a user to select graphical representation or icon(s) of driver or vehicle from generated or updated map, wherein after presentation and before selection updating map including addition or removal of graphical representation of vehicles based on availability of one or more vehicles or drivers, arriving of vehicle(s) in proximity location, making of online or offline status by driver in proximity location vehicle(s), vehicle(s) select by other user(s), cancel selected vehicle by driver of selected vehicle based on one or more reasons;
(i) in response to triggering of selection of graphical representation of driver or vehicle by user from generated or updated map, communicating the first geographic location or pick-up region to the said selected driver; and
(j) communicating, to the user, a location of the said selected driver.

2. The method of claim 1, wherein communicating, to the user, a location of the request accepted selected driver as the vehicle progresses to and/or arrives at the first geographic location or pick-up region and communicating, to the user, various status including driver or vehicle selected, request pending to send, request sent, request received, request pending to accept or confirm or reject, communication start, communication end, request accepted, request rejected, conflict in selected driver or vehicle due to select by other user(s), cancel by driver, cancel trip by user or requestor, arriving, arrived, waiting, trip started, trip end, payment done, ratings provided.

3. The method of claim 1, wherein enabling to self-service listing one or more types of one or more vehicles and drivers, wherein listing details may include name, contact information, photo & video of vehicle and driver, vehicle number, license number, number of seats, type of vehicle, price card, preferences, valid vehicle registration, current insurance policy, tourist permits, valid commercial driver's license, proof of residency or address proof, provided service(s) details, age proof document, verification certificate or badge, accepted payment modes, operated locations.

4. The method of claim 1, wherein configuring a user handset to enable the user to enter input, from which the request for transport is programmatically generated from the user handset and communicated by one or more networks to a corresponding device of the selected driver.

5. The method of claim 4, wherein configuring a user handset includes programming the user handset to automatically determine and include, with the request for transport, (i) geographic information to identify the first geographic location to the device of the request accepted selected driver, and (ii) identification information to identify the user to the selected driver.

6. The method of claim 1, wherein generating or updating, using a processor, map based on said pick-up region or a drop-off region and presenting generated map, wherein map comprise graphical representation or indication of one or more types of one or more matched vehicles including selecting the vehicles based at least in part on a proximity of the second geographic location or location of vehicle to the first geographic location or pick-up region.

7. The method of claim 1, wherein generating or updating, using a processor, map based on said pick-up region or a drop-off region and presenting generated map, wherein map comprise graphical representation or indication of one or more types of one or more matched vehicles including selecting the vehicle or driver based at least in part on a availability or online or offline status, listed, verified, driver preference to operate in or within particular one or more locations, user budget preferences, past selections of vehicles, user rating preferences, user vehicle type preferences, user requirement specification including number of seats, space requirement for goods transport, other required services, verified or non-verified, user schedule to travel, a rating or ranking or weight of at least one of the driver.

8. The method of claim 1, wherein step (e) includes: (i) providing a time limit to enable the selected driver or driver of selected vehicle to accept or decline the request to provide transport for the user; (ii) performing step (f) if the selected driver or driver of selected vehicle accepts the request; else informing user about rejection by selected driver or driver of selected vehicle.

9. The method of claim 8, wherein enabling user and driver to communicating with each other.

10. The method of claim 1, wherein step (g) includes displaying mapping content of the request accepted selected driver progressing to the first geographic location.

11. The method of claim 2, further comprising enabling the user handset to monitor a transport of the user with the request accepted selected driver in order to determine a cost of the transport to the user.

12. The method of claim 2, further comprising enabling party identification information to be programmatically and automatically exchanged between the user handset and the corresponding device of the request accepted selected driver so that the user and driver are able to identify one another at the first geographic location.

13. The method of claim 1, wherein enabling to subscribing or consuming or providing listing service, verification service, matchmaking service, receipt, metering and user to driver payment service, feedback service, support service and communication service.

14. A client device comprising: memory resources that store a set of instructions; network resources configured to enable the user device to communicate on a network; geo-aware sensors that are operable to programmatically determine a location of the user device; one or more processors configured by the set of instructions to: enable a user operating the user device to enter an input to request transport at a first geographic location, wherein request comprise at least one of a pick-up region or a drop-off region; in response to the user entering the input, displaying generated map, wherein map comprise graphical representation or indication of one or more types of one or more matched vehicles; enabling a user to select vehicle from map; in response to the user selection, automatically generate a request for transport by (i) using the geo-aware sensors to determine a geographic location of the user device; and (ii) automatically include data identifying the geographic location in the request for transport; communicate the request for transport using the network resources of the user device including communicating the first geographic location or pick-up region to the selected driver.

15. The user device of claim 14, wherein the one or more processors are configured to include, in the request for transport, information that identifies the user of the user device.

16. The user device of claim 14, wherein the information that identifies the user of the user device includes one or more of (i) an image of the user, (ii) a ratings of the user from any prior requests for transport.

17. The user device of claim 14, wherein the one or more processors are configured to use the network interface to transfer funds for payment of transport from an account associated with the user to an account associated with the request accepted selected driver.

18. A system for directly user to driver arranging transport located at different locations, the system comprising: a plurality of computing devices, the plurality of computing devices including a computing device operated by a user and one or more computing devices operated by one or more drivers; wherein the computing devices of the user and the one or more drivers each comprise: memory resources that store a set of instructions; network resources for enabling the computing device to wirelessly communicate on over a network; geo-aware sensors that are operable to programmatically determine a location of the computing devices; and one or more processors; wherein on the user computing device, the one or more processors are configured by the set of instructions to: enable a user operating the user device to enter an input to request transport at a first geographic location, wherein request comprise at least one of a pick-up region or a drop-off region; in response to the user entering the input, displaying generated map, wherein map comprise graphical representation or indication of one or more types of one or more matched vehicles; enabling a user to select vehicle from map; in response to the user selection, automatically generate a request for transport by (i) using the geo-aware sensors to determine a geographic location of the user device; and (ii) automatically include data identifying the geographic location in the request for transport; communicate the request for transport using the network resources of the user device including communicating the first geographic location or pick-up region to the selected driver; and wherein on each of the one or more computing devices of the selected drivers, the one or more processors are configured by the set of instructions to: enable the selected driver that operates that computing device to accept the request for transport; identify, using the geo-aware sensors, a geographic location of a selected driver as the request accepted selected driver progresses to the user; communicate, using the network resources, information that identifies the geographic location of the request accepted selected driver as the driver progresses to the geographic location of the user.

19. The system of claim 18, further comprising a transport service that selects the driver that selected by user when the user makes the request for transport.

20. The system of claim 18, wherein the computing devices of the user and the one or more transport requesting parties are cellular telephony devices.
